(19) United States
(12) Patent Application Publication
(10) Pub. No.: US 2015/0219786 A1
(43) Pub. Date: Aug. 6, 2015

(54) SYSTEM FOR THE CONTACTLESS INSPECTION OF CONTAINERS, PARTICULARLY ISO CONTAINERS, WITHIN A LOADING AND UNLOADING PLANT

(71) Applicant: Terex MHPS GmbH, Düsseldorf (DE)

(72) Inventors: Armin Wieschemann, Oberhausen (DE); Heinz-Christoph Eichner, Ratingen (DE)

(21) Appl. No.: 14/423,264

(22) PCT Filed: Aug. 19, 2013
(86) PCT No.: PCT/EP2013/067249

§ 371 Date: Feb. 23, 2015

(30) Foreign Application Priority Data
Aug. 24, 2012 (DE) 10 2012 107 815.7

(51) Int. Cl. G01V 5/00; B66F 9/06

(52) U.S. Cl. CPC G01V 5/0066; B66F 9/063

(57) ABSTRACT

The invention relates to a system for the contactless inspection of containers, particularly ISO containers, within a loading and unloading plant, in which system a container is inspected in at least one screening device arranged in an inspection station. The container to be inspected is transported to the inspection station and away from the inspection station by a driverless transport vehicle. In order to create a safe system, the container can be set down in the inspection station for the inspection process by the transport vehicle, the container can be inspected at least by the one screening device that can be moved along the container, and the container can be picked up in the inspection station by the transport vehicle.

### CROSS-REFERENCE TO RELATED APPLICATIONS

This application claims the benefit of International Application No. PCT/EP2013/067249, filed on Aug. 19, 2013, and also of German Application No. 10 2012 107 815.7, filed on Aug. 24, 2012, both of which are incorporated herein by reference in their entireties.

### FIELD OF THE INVENTION

The present invention relates to a system for the contactless inspection of containers, particularly ISO-containers, within a loading and unloading plant.

### BACKGROUND OF THE INVENTION

German laid-open document DE 103 13 248 A1 discloses a manned mobile platform for contactless inspection of containers. The containers are loaded and unloaded in ports by means of a container bridge. As far as function is concerned, the platform can be compared to a gantry crane and can be moved along a quay via a gantry frame on rails in parallel with and below a container bridge and independently of the container bridge. To pick up containers to be inspected from the quay and to be able to set them down after inspection, the platform has a lifting device and a set-down location for the containers, which is arranged on the gantry crane. A screening device is arranged in the region of the set-down location and consists essentially of a radiation source, an oppositely arranged radiation detector and a shield. By means of the radiation source the container is screened substantially horizontally using X-rays or gamma-rays. The shield serves to protect the people operating the platform or the screening device.

Furthermore, German laid-open document DE 11 2004 001 701 T5 describes a system for the inspection of goods in a container in port areas. The container is located on a transport surface of a lorry. The system consists essentially of a screening device and a towing device for the lorry. The screening device is stationary and has a radiation source, a first collimator, a second collimator, and a detector. The radiation source is pivotable to orient the screening rays emitted therefrom with respect to the vertical position of the container on the lorry. It is possible to adapt the screening device to different vertical heights of the transport surfaces of the lorries. The container is screened substantially horizontally. Since the screening device is stationary, the lorry is towed by the towing device along a screening channel and past the screening device. The towing device consists of a towing carriage that is pulled along the screening channel via a winch and a steel cable. The lorry is connected in a clamping manner to the towing vehicle via its front wheels.

Furthermore, German laid-open document DE 10 2009 025 051 A1 describes a driverless heavy goods transport vehicle for containers. The areas where this transport vehicle is said to be used are the loading and unloading of containers in port areas and intermodal transport between road and rail, in which the transport vehicle carries out its transport tasks in unmanned automatic operation. The floor-bound heavy goods transport vehicle has rubber tires and is a four-wheeled vehicle. It consists essentially of a vehicle chassis on which two front wheels are mounted on a front axle and two rear wheels are mounted on a rear axle. The vehicle chassis carries a level platform that serves to receive the containers to be transported. The platform can be designed to be passive, such as the containers are picked up or set down thereon by a suitable handling device. This platform can also be designed to be active. In that case the platform can be raised and lowered by a lifting device and can pick up the containers from a stationary support frame and set them down thereon. The transport vehicle is driven by one electric motor per axle, these motors being powered by a lead battery suspended on and below the vehicle chassis.

Furthermore, U.S. patent application publication No. 2008/0025825 A1 describes a system for screening containers in a port area. The containers are loaded and unloaded by a quay crane onto driverless transport vehicles. The driverless transport vehicles travel with the containers through a screening device, in which the containers are screened horizontally. The containers are then conveyed in a transfer device through a fence into an area of the quay where manned vehicles can travel and the containers are picked up by manned container transport vehicles.

German patent application DE 10 2007 063 201 A1 relates to a screening device for freight containers through which a lorry can travel and that has horizontally and vertically oriented detectors.

German patent application DE 101 60 928 A1 discloses a screening device for freight containers, which is arranged on an intermediate support of a container-handling bridge having a crane trolley. The screening device has, in addition to an X-ray device, support frameworks for setting down the containers to be screened. The containers are set down on the support frameworks and picked up therefrom by the crane trolley. The screening device can travel horizontally as a whole on the intermediate support.

U.S. patent application publication No. 2005/036854 A1 discloses a system for the contactless inspection of containers. The system has a bridge crane, which does not have to travel on the floor, and an inspection station elevated below the bridge crane having a movable screening device. In order to inspect a container, said container must be raised into the inspection station by means of the bridge crane by a floor-bound, manned transport vehicle and held at that location. The bridge crane then moves the container away from the inspection position and unloads it onto the transport vehicle.

German laid-open document DE 10 2004 050 421 A1 describes a system wherein a container to be inspected is raised into an elevated inspection station by means of a crane.

German utility model DE 203 09 047 U1 describes a system for the contactless inspection of containers. The system has an inspection station in the form of a scanning channel having a stationary screening device. A container to be inspected is transported to the scanning channel by a manned heavy-goods vehicle and is pulled through the scanning channel during the inspection process by means of tow cables. Then, the container is transported away from the scanning channel by the heavy-goods vehicle.

### SUMMARY OF THE INVENTION

The present invention is a safe system for the contactless inspection of containers, particularly ISO-containers, within a loading and unloading plant. In accordance with one form of the present invention, a system for the contactless inspection of containers, particularly ISO-containers, within a loading and unloading plant, includes an inspection station, at least one screening device arranged in the inspection station, a driverless transport vehicle that is floor-bound, has rubber tires, and is guided by automatic operation. The driverless transport vehicle is configured to transport the container to be inspected to and away from the inspection station, and safe inspection is achieved because the driverless transport vehicle is configured to set down the container in the inspection station, the at least one screening device is configured to move along the container and inspect the container, and the driverless transport vehicle is configured to pick up the container in the inspection station. The moveable screening device can include a gantry scanner. In addition, a moveable detector can be provided, wherein the moveable detector can travel below the container in the inspection station. For this purpose, the moveable detector may be, for example, a rail carriage or a driverless transport vehicle with rubber tires. Thus, in the illustrated embodiment, movement of the gantry scanner and possibly of the moveable detector are synchronised.

In one aspect, the inspection or screening or scanning process in the inspection station are integrated into the operation of automatically moveable transport vehicles, and the scanning of the container can be effected without people being present in the vicinity of the container. Therefore, no additional protective measures for drivers of transport vehicles or lorries are required. Containers that are recognized as hazardous can also be disposed of without human intervention.

Optionally, the system further includes a first screening device configured to horizontally screen the container. Moreover, the system may include a second screening device that is configured to vertically screen the container. This further increases the level of safety.

In a constructionally advantageous embodiment, a stationary support frame is arranged in the inspection station in the region of the at least one screening device. The driverless transport vehicle is configured to set down the container for the inspection process on the stationary support frame and pick up the container from the stationary support frame.

The system in accordance with the present invention may be particularly suitable for a loading and unloading plant in a port area, for containers such as sea freight containers.

These and other objects, advantages and features of the invention will become apparent upon review of the following specification in conjunction with the drawings.

### BRIEF DESCRIPTION OF THE DRAWINGS

FIG. 1 is a water-side top view of a loading and unloading plant for containers in a port area;

FIG. 2 is an enlargement of the overview plan of FIG. 1 from the region of an inspection station;

FIG. 3 is a front view of a container in the inspection station shown in FIG. 2; and

FIG. 4 is a front view of a transport vehicle with a container.

### DESCRIPTION OF THE PREFERRED EMBODIMENTS

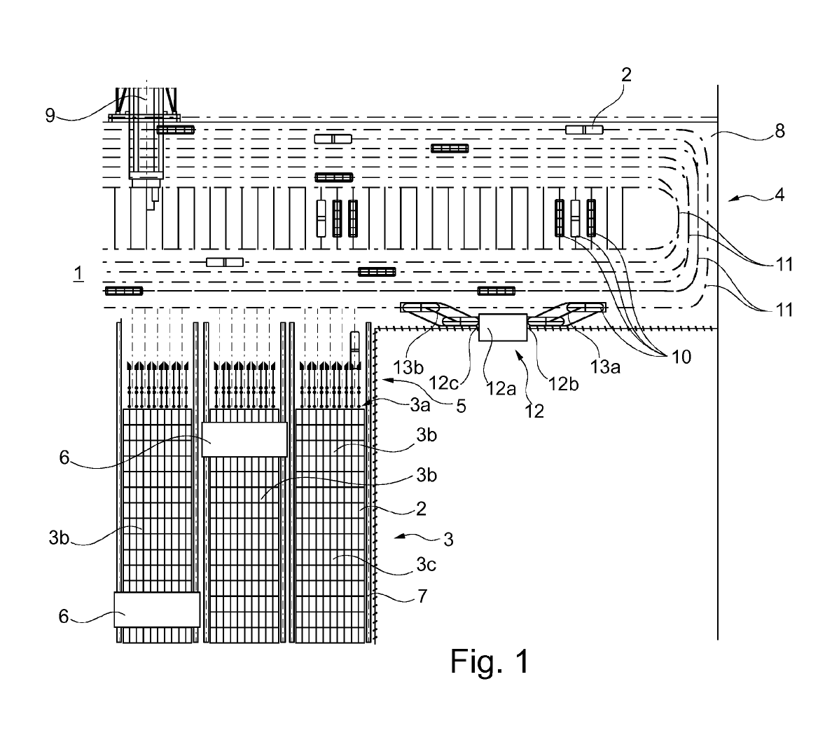

Referring now to the drawings and the illustrative embodiments depicted therein, a system for the contactless inspection of containers is shown in FIG. 1 by a water-side top view of a loading and unloading plant 1 in a port area, in which containers 2 are loaded and unloaded. In the illustrated embodiment, containers 2 are ISO-containers. ISO-containers weigh up to about 38 tons and are generally understood to be standardized large-capacity boxes with standardized pick-up points or corners to facilitate picking-up the ISO-containers. ISO-containers are conventionally 20, 40 or 45 feet long. ISO-containers with a length of 53 feet are already available. In the field of ISO-containers, refrigerated containers—known as reefers—and a number of other container types are also used, in addition to closed containers.

The overview plan of FIG. 1 shows only a section of the loading and unloading plant 1 but allows some of the essential components to be seen. The loading and unloading plant 1 includes a land-side loading and unloading area (not shown) a store 3, and a water-side loading and unloading area 4.

The store 3 consists of a plurality of storage areas 3b arranged in parallel next to each other and in lines, each being allocated a water-side area 5 for placement into and out of storage at its water-side end 3a. Each storage area 3b has one or more container stacking cranes 6 that can travel along the storage areas 3b on shared or separate rails 7. In the illustrated embodiment, each storage area 3b has two container stacking cranes 6. The container stacking cranes 6 transport the containers 2 between the storage area 3b and a land-side loading and unloading region (not shown) and the water-side area 5 for placement into and out of storage. Each storage area 3b also has a set-down area 3c for the containers 2 in addition to the one or more container stacking cranes 6. The set-down area 3c has a rectangular and elongate base surface on which the containers 2 can be arranged in rows and columns and can be intermediately stored by stacking one container 2 on top of another.

Each of the water-side areas 5 for placement into and out of storage is an interface between the store 3 and the water-side loading and unloading area 4 which, in the illustrated embodiment, corresponds substantially to a quay 8 where the ships to be loaded and unloaded (not shown) are moored. For the purpose of loading and unloading the ships, the containers 2 are conveyed by driverless transport vehicles 10 between the areas 5 for placement into and out of storage and handling bridges 9 arranged along the quay 8. These driverless transport vehicles 10 can generally travelling platforms on which the containers 2 are set down for transportation. In the illustrated embodiment, the travelling platforms can be passive, and therefore the containers 2 are loaded and unloaded by the container stacking crane 6, the handling bridge 9, or other available handling devices. The driverless transport vehicles 10 can also have an active platform—i.e. one which can be raised and lowered—to actively set down or pick up the container 2 onto or from stationary support frames (not shown) in the region of the areas 5 for placement into and out of storage of intermediate storage locations and/or the handling bridges 9. The transport vehicles 10 can be battery-operated or have a diesel-electric drive, and are guided by automatic operation. Accordingly, the transport vehicles 10 are operated unmanned. FIG. 1 shows virtual lanes 11 for the transport vehicles 10 to indicate the usual travel routes thereof. However, the transport vehicles 10 can be navigated freely.

Furthermore, in the region of the water-side loading and unloading area 4, an inspection station 12 is arranged in which the containers 2 and their content can be subjected to contactless inspection for the purpose of discovering banned and/or hazardous objects or substances in the container 2.

This inspection station 12 is at the edge of, and outside, the conventional lanes 11 for the transport vehicles 10 in the water-side loading and unloading area 4 and is designed as a stationary building 12a. In order for the transport vehicles 10 to be able to reach the inspection station 12, the outermost of the lanes 11 is adjoined by a departure lane 13a that ends at an entry 12b of the inspection station 12. The opposite end of the inspection station 12 is adjoined by an exit 12c that is connected via an approach lane 13b to the outermost of the lanes 11. The inspection station 12 is therefore arranged in parallel, and outwardly offset with respect to the outer lane 11.

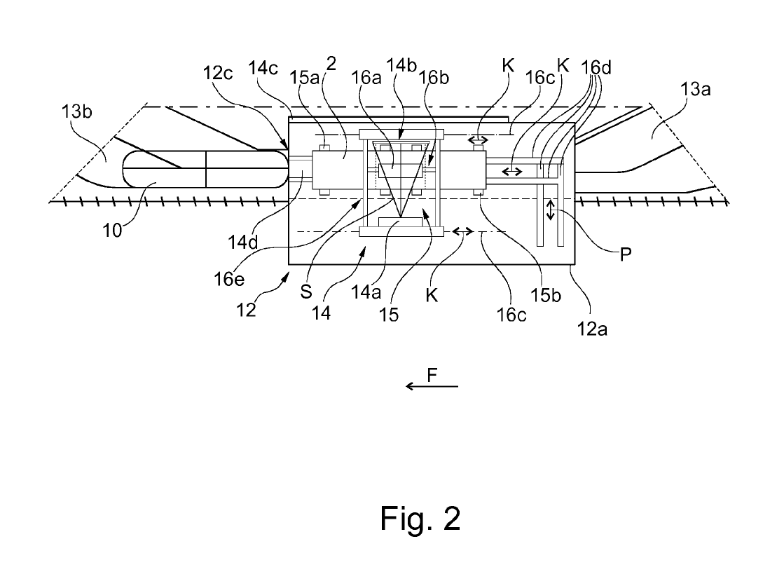

FIG. 2 shows an enlargement of a section of FIG. 1 from the region of the inspection station 12. The inspection station 12 includes a cuboidal building 12a, the roof thereof not being shown for the sake of the clarity of FIG. 2 so that the other components of the inspection station 12 in the building 12a can be seen. The inspection station 12 for the contactless examination of the containers 2 and/or the load in the container 2 has a screening device 14 known from the prior art, which consists essentially of a first horizontally oriented radiation source 14a for X-ray and/or gamma-radiation, the rays of which are indicated by the lines S, and of an oppositely arranged radiation detector 14b. The screening device 14 along with the radiation source 14a and the radiation detector 14b oppositely adjoin a screening channel 14d formed as a lane for the transport vehicles 10. The radiation source 14a substantially horizontally screens the container 2 and the load by at least one of X-rays and gamma-rays. The stationary building 12a, with its outer wall, serves as a shield 14c.

This arrangement and design of the inspection station 12 of the illustrated embodiment has the advantage that the container 2 to be inspected is already located on a driverless transport vehicle 10 in the water-side loading and unloading area 4, and therefore can easily be moved by the driverless transport vehicle 10 to the inspection station 12 for examination. Since the transport vehicle 10 is driverless, it is not necessary for drivers to get in or out or to protect them against the inspection radiation, and unmanned conveyance of the transport vehicle 10 or of the container 2 is not required.

In this inspection station 12, in addition to contactless inspection of the containers 2 in the horizontal direction, inspection in the vertical direction is also possible (see FIG. 2). For this purpose the container 2 in the inspection station 12 is set down by the driverless transport vehicle 10 onto a stationary support frame 15. The support frame 15 includes eight pillars 15a arranged in travel direction F of the automated transport vehicle 10 to the right and left of an inspection channel 14d. The container 2 rests with short, narrow portions of its lateral right and left lower surface 2c on the pillars 15a. For the set-down process and the subsequent pick-up process, the transport vehicle 10 is fitted with a platform-like lifting table 10b that can be raised and lowered. For the set-down process the transport vehicle 10 with the raised lifting table 10b travels into the support frame 15a, and so the lower surface 2c is located over contact surfaces 15b of the pillars 15a and then lowers the container 2 onto the support frame 15. For the pick-up process, the transport vehicle 10 with the lowered lifting table 10b travels into the support frame 15 until it comes to a stop below the container 2 to be picked up. The lifting table 10b is then raised in the direction of the lower surface 2c of the container 2 until the lifting table 10b lifts the container 2 from the contact surfaces 15b of the pillars 15a. The dimensions of the lifting table 10b and of the pillars 15a are selected such that the lifting and lowering process can be effected unhindered.

Since the support frame 15 supports the container 2 only from below in the region of its long sides and the transport vehicle 10 is moved out from under the container 2, the container 2 can be scanned in the vertical direction. For this purpose, a second screening device 16 is provided as a moveable gantry 16e. The gantry 16e includes a radiation source 16a above the container 2 on a cross-beam, the radiation source 14a of the first screening device 14 on one side and the radiation detector 14b on the opposite side.

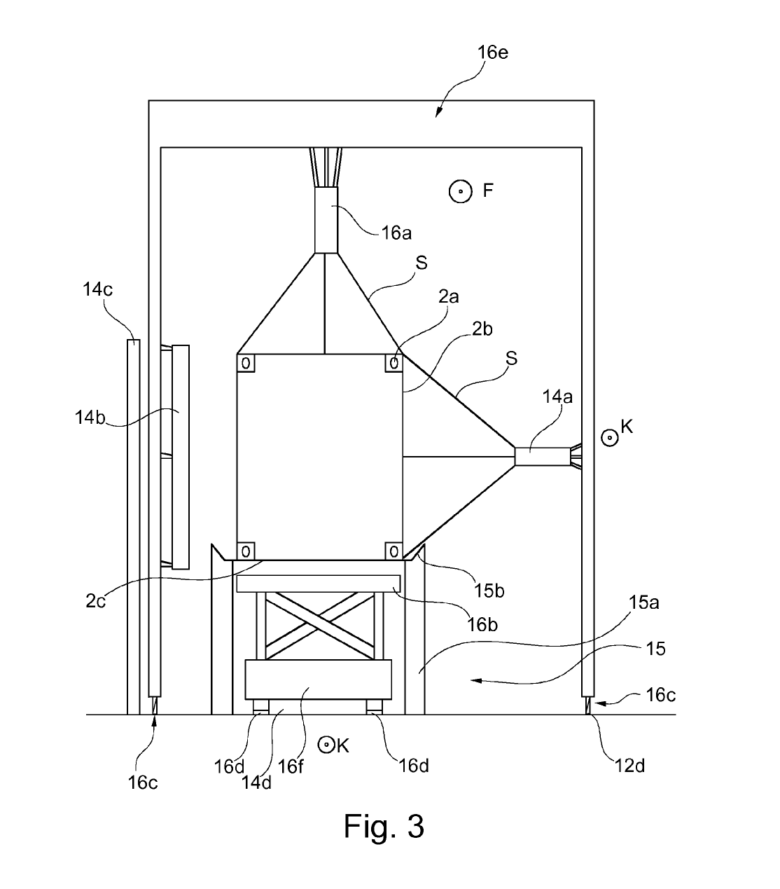

The radiation detector 16b is shown below the container 2 in FIG. 3, and travels on a rail-bound carriage 16f.

Since the container 2 to be inspected now rests in the inspection station 12 on the support frames 15, the first and second screening devices 14, 16 are designed to be able to move along container 2, and therefore the support frame 15, in an inspection direction K, wherein their movements are synchronised.

Rails 16c are provided for the gantry 16e and rails 16d are provided for the carriage 16f, these extending on a floor of the inspection station 12 and in parallel with the travel direction F.

Since the lower rails 16c and 16d extend in the region of the screening channel 14d so that the radiation detector 16b can be guided closely along the lower side 2c of the container 2, the radiation detector 16b arranged on the carriage 16f is moved out of the screening channel 14d after the inspection process. For this purpose, the lower rails 16d bend at a right angle outside the support frame 15 and so the radiation detector 16b can be moved into a parking position in a parking direction P. It will be understood that the rails 16c, d can also extend in a curve. In an alternative embodiment, the detector 16b may include a rubber-tired driverless transport vehicle.

The travel paths for the radiation source 14a of the first screening device 14, the radiation detector 14b of the first screening device 14, and the radiation source 16a of the second screening device 16 are located outside the screening channel 14d through which the transport vehicle 10 with the container 2 travels. Thus, the rails 16c do not have to bend, but only extend in the travel direction F.

A container 2 classed as hazardous or a container 2 with a banned load can then be transported by the driverless transport vehicle 10 directly into a safety area (not shown) and automatically unloaded at that point. This safety area can also be protected against explosions.

FIG. 3 shows a front view of a container 2 in the inspection station 12 of FIG. 2. The container is set down on a support frame 15. For reasons of clarity, the building 12a of the inspection station 12 is not shown in FIG. 3.

As shown in FIG. 3, transport vehicle 10 has already moved out from under the container 2 and the carriage 16f of the radiation detector 16b of the second screening device 16 has travelled out of its parking position via the rails 16d into the screening channel 14d in which the transport vehicle 10 has previously travelled. The container 2 rests with its lower surface 2c in the region of the lateral edges on the contact surfaces 15b of the pillars 15a of the support frame 15.

Since, in this embodiment, the container 2 rests in an inspection position for the horizontal and vertical inspection process, the first and second screening devices 14 and 16 are to be moved in synchronism along the container 2 in the inspection direction K.

For this purpose, the radiation source 14a, the radiation detector 14b of the first screening device 14, and the radiation source 16a of the second screening device can travel together because the gantry 16e has wheels on the rails 16c. The fourth driven carriage 16f of the radiation detector 16b runs via its wheels on the two lower rails 16d. The rails 16d in the region of the screening channel can also be let into the floor 12d so as not to impair the travelling movement of the transport vehicle 10.

To scan the container 2, the gantry 16e and the carriage 16f travel in synchronism along the container gradually to cover the whole container 2, and in so-doing to screen it. Therefore, the radiation sources can be weaker and the detectors can be smaller since the whole container does not have to be screened at once.

FIG. 3 shows the radiation source 14a of the first screening device 14 arranged laterally next to the screening channel 14d and at a height that corresponds approximately to the middle height of a container 2 on the transport vehicle 10. Thus, the X-rays or gamma-rays of the radiation source 14a screen the whole container 2 as shown by the lines S. Starting from the radiation source 14a, the X-rays or gamma-rays pass through the right-hand long side 2b of the container 2 into the container 2, migrate through it and exit on the opposite left-hand long side 2b of the container 2. At that location, the X-rays and gamma-rays reach the radiation detector 14b that is arranged in parallel with the opposite long side 2b of the container 2 and at a slight distance therefrom. The size of the radiation detector 14b, therefore corresponds at least to the size of the long side 2b of the container 2 to be inspected. The radiation detector 14b is connected in a conventional manner to evaluation devices to obtain the desired screening image of the contents of the container 2. The same is true for the vertical radiation source 16a and the radiation detector 16b thereof.

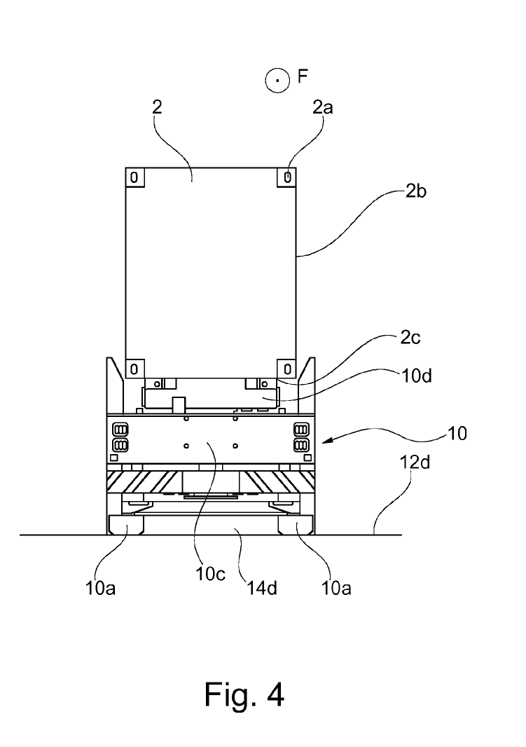

FIG. 4 shows a front view of the driverless transport vehicle 10 with a container 2. Transport vehicle 10 includes a vehicle chassis 10c that can travel on the floor 12d in an automatically guided manner via a total of four rubber tires 10a on a front and a rear axle. A first lifting table 10d, which can be raised and lowered, and, therebehind against the travel direction F, a second lifting table 10e, which can be raised and lowered, are arranged on the vehicle chassis 10c. A long 40 or 45 foot container 2 or two 20 foot containers one behind the other rest on the lifting tables 10d and 10e. Each substantially cuboidal container has, in a conventional manner, corner fittings 2a, long sides 2b and a lower surface 2c, with which the container 2 rests on the lifting table 10d, 10e.

The inspection station 12 can fundamentally also be designed as a mobile housing unit and can be arranged at other suitable sites in the water-side loading and unloading area 4. For example, an arrangement in the region of the handling bridges 9 is particularly suitable. The inspection station 12 can then be moved independently of the handling bridges 9 but, if necessary, also jointly with the handling bridge 9 along the quay 8. This inspection station 12 may adjoin the lane 11 closest to the water. Furthermore, the inspection station 12 can be foldable. The operation of the inspection station 12, therefore, is adaptable to the operating conditions of the container terminal.

The first to the fourth carriages or gantries 14g, 14h, 16e and 16f of the moveable first and second screening devices 14 and 16, the first to the fourth carriages or gantries 14g, 14h, 16e and 16f are able to travel on rails. Alternatively any types of displacement along guides are feasible as long as they produce little shaking so as not to impair the screening result. Linear or sliding guides are feasible. Rubber-tired running gears are also feasible.

Changes and modifications to the specifically described embodiments may be carried out without departing from the principles of the present invention, which is intended to be limited only by the scope of the appended claims as interpreted according to the principles of patent law including the doctrine of equivalents.

1. A system for the contactless inspection of containers, particularly ISO-containers, within a loading and unloading plant, the system comprising:
an inspection station, having at least one screening device arranged in the inspection station;
a floor-bound driverless transport vehicle having rubber tires and guided by automatic operation, wherein the driverless transport vehicle is configured to transport a container to be inspected to and away from the inspection station, and to set down the container for an inspection process in the inspection station;
wherein the at least one screening device is configured to move along and inspect the container; and
wherein the driverless transport vehicle is configured to pick up the container after the inspection process in the inspection station.

2. The system of claim 1, wherein the at least one screening device comprises a first screening device that is configured to horizontally screen the container.

3. The system of claim 1, wherein the at least one screening device is configured to vertically screen the container.

4. The system of claim 1, further comprising a stationary support frame arranged in the inspection station in a region of the at least one screening device wherein the driverless transport vehicle is configured to (i) set down the container for the inspection process on the stationary support frame and, (ii) after the inspection process, pick up the container from the stationary support frame.

5. The system of claim 1, further in combination with the loading and unloading plant, wherein the loading and unloading plant is arranged in a port area and the containers are sea-freight containers.

6. The system of claim 4, wherein the at least one screening device is configured to vertically screen the container.

7. The system of claim 5, wherein the at least one screening device is configured to vertically screen the container.

8. The system of claim 7, further comprising a stationary support frame arranged in the inspection station in a region of the at least one screening device, wherein the driverless transport vehicle is configured to (i) set down the container for the inspection process on the stationary support frame and, (ii) after the inspection process, pick up the container from the stationary support frame.

9. The system of claim 2, further comprising a second screening device configured to vertically screen the container.

10. The system of claim 2, further comprising a stationary support frame arranged in the inspection station in a region of the at least one screening device, wherein the driverless transport vehicle is configured to (i) set down the container for the inspection process on the stationary support frame and, (ii) after the inspection process, pick up the container from the stationary support frame.

11. The system of claim 10, further comprising a second screening device configured to vertically screen the container.

12. The system of claim 11, further in combination with the loading and unloading plant, wherein the loading and unloading plant is arranged in a port area and the containers are sea-freight containers.

13. The system of claim 4, further in combination with the loading and unloading plant, wherein the loading and unloading plant is arranged in a port area and the containers are sea-freight containers.

14. The system of claim 2, further in combination with the loading and unloading plant, wherein the loading and unloading plant is arranged in a port area and the containers are sea-freight containers.
